(19) United States
(12) Patent Application Publication
(10) Pub. No.: US 2005/0154624 A1
(43) Pub. Date: Jul. 14, 2005

(54) Scenario-oriented solution maps

(76) Inventors: Stefan Hack, Wiesloch (DE); Liezl Schulte, Heidelberg (DE)

Correspondence Address: FISH & RICHARDSON, P.C., PO BOX 1022, MINNEAPOLIS, MN, 55440-1022, US

(21) Appl. No.: 10/756,029

(22) Filed: Jan. 13, 2004

(51) Int. Cl. G06F 17/60

(52) U.S. Cl. 705/7

(57) ABSTRACT

Displaying information relating to a business includes obtaining an aspect of the business that can affect an objective of the business, obtaining a business scenario that corresponds to the aspect, obtaining a business process in the business scenario, and generating a map for display that associates the business process, the business scenario, and the aspect.

### TECHNICAL FIELD

This patent application relates generally to processing by a digital computer. More particularly, the application relates to modeling a business using business scenarios and, still more particularly, to generating a map that models a business using business scenarios that can affect the likelihood of achieving a business objective.

### BACKGROUND

Modern businesses integrate numerous processes across various disciplines to achieve an objective. For example, the business objective of an engineering firm might be to deliver an end product to a distributor. To achieve this objective, the engineering firm may need to employ, and to integrate, processes relating to engineering design, parts procurement, personnel, and manufacturing. Keeping track of such disparate processes, and the numerous process steps contained therein, has proven to be a difficult task.

To assist in this task, and thus in gaining control over various processes that make up the business, the concept of “business modeling” has been developed. In one form, business modeling may include creating “maps” that define and integrate various processes that span a business. Numerous types of business maps exist today. For example, in an engineering context, existing business maps can support a range of business processes, from specification and design, to construction and manufacturing, while at the same time integrating information relating to business partners.

Business maps are not static documents, but rather may take advantage of existing technology, such as hypertext markup language (HTML). For example, business maps may be constructed using HTML, with hypertext links to other business maps and/or other business-related information. As such, business maps can be a valuable tool in understanding and coordinating business activities.

### SUMMARY

In general, in one example, the invention is directed to a method of displaying information relating to a business. The method includes obtaining an aspect of the business that can affect an objective of the business, obtaining a business scenario that corresponds to the aspect, obtaining a business process in the business scenario, generating a map that associates the business process, the business scenario, and the aspect, and displaying the map. The method may include one or more of the following features.

The aspect of the business may be a business lever that enhances likelihood of success in (or, e.g., ensures success in) the business. The map may contain a hyperlink that connects the business scenario to the business process. The map may contain a hyperlink associated with the business scenario. The hyperlink may display a page containing information associated with the business scenario. The page may contain one or both of a description of the business scenario and an element of the business process.

The element may be a process step that is included within the business process. The element may contain a hyperlink to a Web page containing a product (e.g., a software tool) to implement the element. The map may contain an industry value chain associated with the business. The industry value chain may contain activities of the business associated with achieving the object. The aspect of the business may be related to one or more activities of the industry value chain. The map may display the aspect relative to the business scenario and may contain a link to information about the business process. The map may contain links to an enterprise resource map. The enterprise resource map may contain process categories with links to process steps that comprise the categories.

Other features and advantages will be apparent from the description, the drawings, and the claims.

### DESCRIPTION OF THE DRAWINGS

FIG. 1 is a diagram of a scenario-oriented solution map for the automotive OEM industry.

FIG. 2 is a diagram of a page describing a key industry business scenario that may be linked to via the scenario-oriented solution map of FIG. 1.

FIG. 3 is a diagram of the scenario-oriented solution map of FIG. 1 with elements of its enterprise resource planning area displayed.

FIG. 4 is a diagram of a page that may be linked to via the enterprise resource planning area of the scenario-oriented solution map of FIG. 1.

FIG. 5 is a diagram of a scenario-oriented solution map for the semiconductor industry.

FIG. 6 is a diagram of a scenario-oriented solution map for the retail industry.

FIGS. 7 to 19 show various pages that can be linked to via the scenario-oriented solution map of FIG. 6.

FIG. 20 is a flowchart showing a process for generating scenario-oriented solution maps.

FIGS. 21 to 23 show an alternative scenario-oriented solution map for the automotive OEM industry.

Like reference numerals in different figures indicate like elements.

### DETAILED DESCRIPTION

The scenario-oriented solution maps (or simply “solution maps”) described below may be generated and displayed on a computer or any other type of processing device. In the embodiments described below, it is assumed that the solution maps are generated and displayed on a computer connected both to an intranet and the Internet. As noted below, however, the solution maps may be implemented in other contexts.

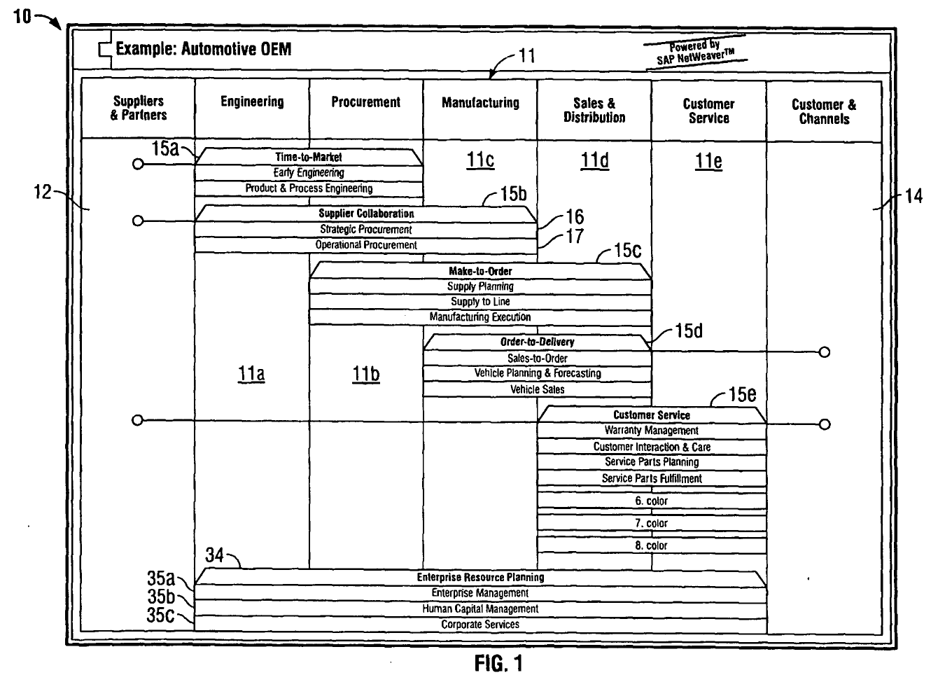

Referring to FIG. 1, a solution map 10 is constructed across an industry value chain 11. An industry value chain contains a set of interlocking elements 11a to 11e of a business that generate value for customers of the business. Each value chain element can be conceptualized as a distinct value-adding activity. When viewed together, the value chain elements define a simple, yet effective, approach to understanding and analyzing a business. A business value chain may include any number of elements, but typically includes between five and seven elements. These elements may extend across business departments, disciplines, or even across different companies.

FIG. 1 depicts an industry value chain for an automotive original equipment manufacturer (OEM). In this example, elements 11a to 11e include engineering, procurement, manufacturing, sales and distribution, and customer service. Other elements may also be included and/or one or more may be omitted. Elements 11a to 11e are ordered chronologically, from the start of the business process at engineering 11a, to its completion at customer service 11e. It is noted that there may be some overlap in the actual business activities; however, for the sake of modeling, elements 11a to 11e are depicted as discrete.

Solution maps may be extended, as shown in FIG. 1, to incorporate, into industry value chain 11, activities of external parties, such as suppliers and customers. This is referred to as an “extended enterprise” view, since it shows activities that are peripheral to a business core. The peripheral activities, namely supplier element 12 and customer element 14, correspond to activities performed by typical suppliers and customers of the industry. For example, in the automotive industry, the customer element may include information relating to distributors, such as automotive dealerships, or other customers in the overall supply chain. The supplier element may include, e.g., information relating to suppliers to the industry value chain, such as raw material suppliers and the like. It is noted that the peripheral elements are not limited to those described here.

Solution map 10 identifies aspects 15a to 15e of the business that reflect core competencies or business levers within an industry. These aspects, referred to herein as “pain points”, are tailored to typical business needs of a company in the industry, and correspond to core competencies or business levers that enhance the likelihood of succeeding in that particular industry (e.g., “Time-to-Market”, “Supplier Collaboration”, etc.). The aspects are thematic, meaning that they correspond to a general theme that encompasses one or more business scenarios (defined below).

In the automotive OEM example of FIG. 1, the aspects (pain points) include, inter alia, time-to-market 15a and suppliers collaboration 15b. These aspects of the business relate to, respectively, the time it takes to bring a product to market and collaboration with various suppliers. Included within each aspect of industry value chain 11 are one or more business scenarios. A business scenario is a collection of one or more business processes that are self-contained and that define an end-to-end business task comprehensively. A business scenario may include an ordered sequence of business processes, as shown below.

In the automotive OEM example, suppliers collaboration 15b includes business scenarios for strategic procurement 16 and operational procurement 17. Both of these business scenarios relate to obtaining something from a supplier; hence, they are both grouped under the aspect “supplier collaboration”. Strategic procurement 16 relates to obtaining talent (e.g., engineers, laborers, etc.) needed to fulfill roles in elements of the industry value chain. Operational procurement 17 relates to obtaining products (e.g., raw materials, parts, etc.) needed in elements of the industry value chain.

As shown in FIG. 1, aspects 15a and 15e (and their corresponding business scenarios) may extend across two or more elements of industry value chain 11. This indicates, graphically, that those aspects can have an effect on the elements across which they extend. In the example of FIG. 1, strategic procurement 16 can have an effect on both engineering and manufacturing. In strategic procurement, hiring of engineers affects engineering effort and hiring of laborers affects the manufacturing effort. In operational procurement, the ability to obtain parts, raw materials, and other essentials can likewise have an effect on engineering, procurement, and manufacturing efforts.

As noted above, a business scenario includes a set of business processes that address a business objective. A business process is a collection of activities that receive input and that create output that is of value to a customer. A business process typically comprises a set of logically-related process steps that can span across departments or even companies. These process steps may be performed manually or automatically, e.g., by a person, by a machine, or by a person using a machine (e.g., a person using a computer).

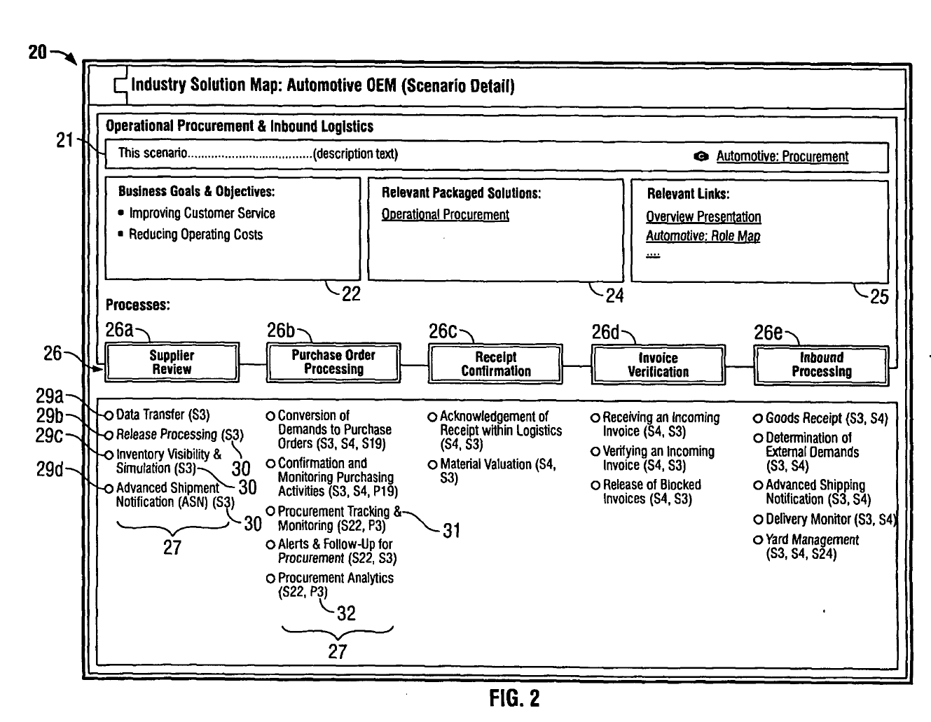

Solution map 10 may be implemented as a Web page using HTML. As such, solution map 10 may provide hyperlinks to other pages that can be accessed with a mouse by “pointing and clicking”. The business scenarios of solution map 10 may contain embedded hyperlinks, which direct the user to pages containing descriptions of the business scenarios. In the example of FIG. 1, the operational procurement business scenario 17 contains a hyperlink that allows a user to “drill down” to page 20 (FIG. 2).

Page 20 contains a description 21 of business scenario 17, along with other information relating to business scenario 17. For example, page 20 may contain a description of objectives 22 associated with the business scenario, a description of packaged solutions 24 (e.g., software) for use with the business scenario, and relevant links 25 to information relating to the business scenario. Page 20 also display the various business processes 26 that make up the business scenario. In the example of FIG. 2, these business processes include, inter alia, supplier review 26a and purchase order processing 26b. Supplier review 26a includes activities relating to assessing the qualifications of, and product available from, various suppliers. Purchase order processing 26b includes activities relating to drafting and tracking purchase orders from various suppliers.

Each business process contains process steps 27 that are performed as part of the overall business process. The process steps may be performed manually or automatically, e.g., by a person, by a machine, or by a person using a machine (e.g., a person using a computer). By way of example, the “supplier review” business process contains the following process steps: data transfer 29a, release processing 29b, inventory visibility and simulation 29c, and advanced shipment notification 29d.

Page 20 contains links 30 to Web pages (not shown) that describe products that may assist in performing the process steps. More than one link may be provided per process step, as shown with respect to process step 31. Similarly, different types of links may be provided, e.g., those beginning with “S” and those beginning with “P”. The “S” links, such as link 30, may refer to products available via the provider of solution map 10, such as SAP® AG of Walldorf, Germany. The “P” links, such as link 32, may refer to products available through partners of the supplier. The Web-pages may be available via the Internet or an intranet within a company. Other types of links also may be provided, such as informational or other non-product-related links.

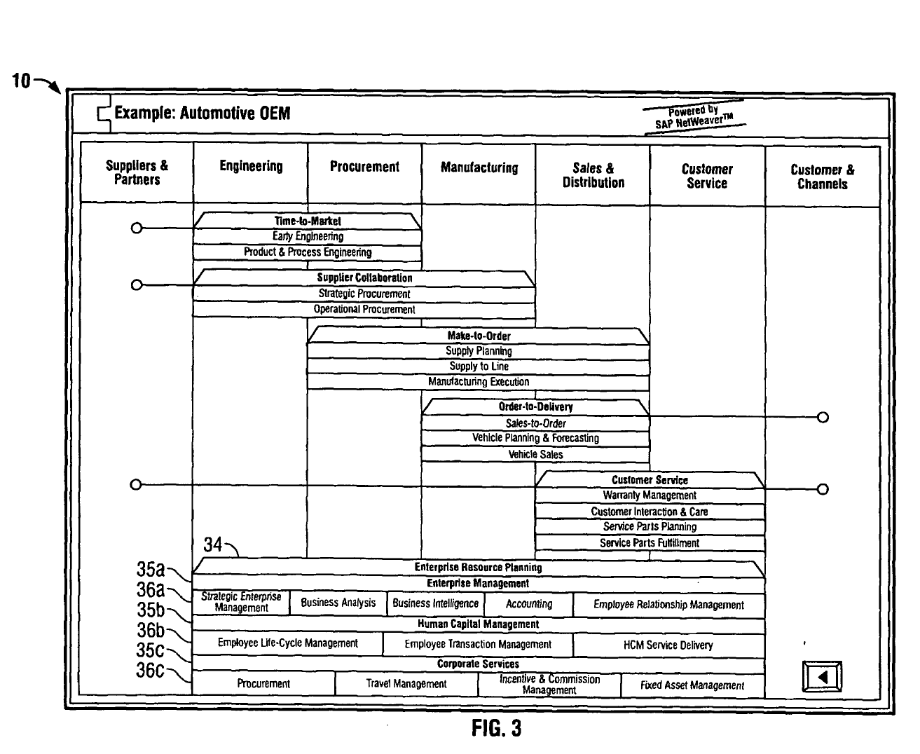

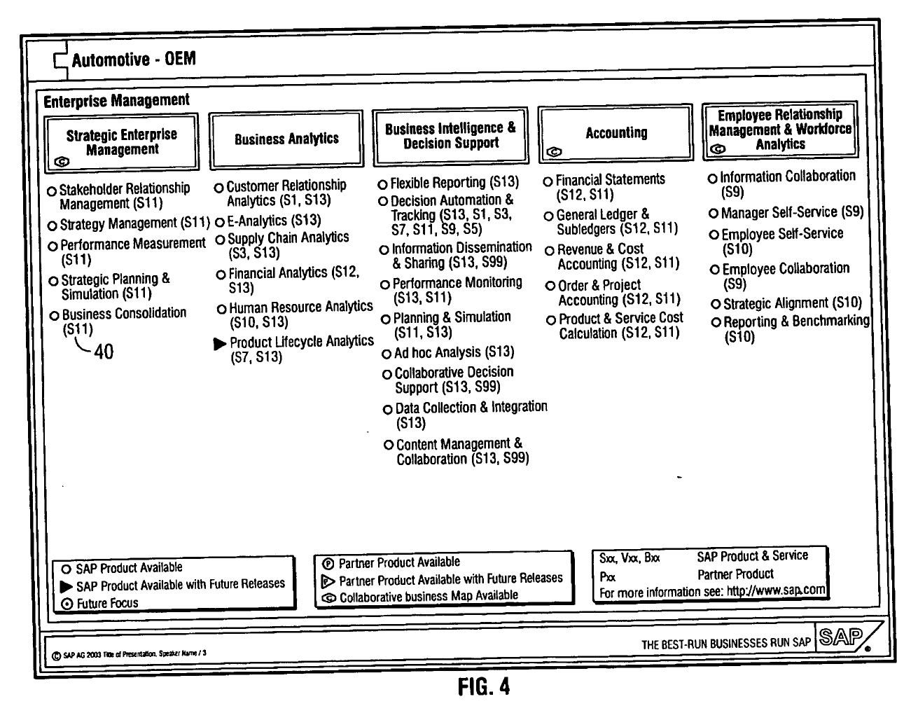

Referring back to FIG. 1, solution map 10 also contains enterprise resource planning (ERP) information 34. ERP information 34 contains links to maps that define the business in terms of traditional business process categories 35a to 35c with links to process steps that comprise those categories. The business process categories include enterprise management 35a, human capital management 35b, and corporate services 35c. Corresponding process steps 36a to 36c may be listed below each process category, as shown in FIG. 3. The business process categories may contain an embedded hyperlink, which directs a user to page 39 shown in FIG. 4. Page 39, like page 20 (FIG. 2), provides links 40 to Web pages containing various products that may be used to perform the corresponding business process step.

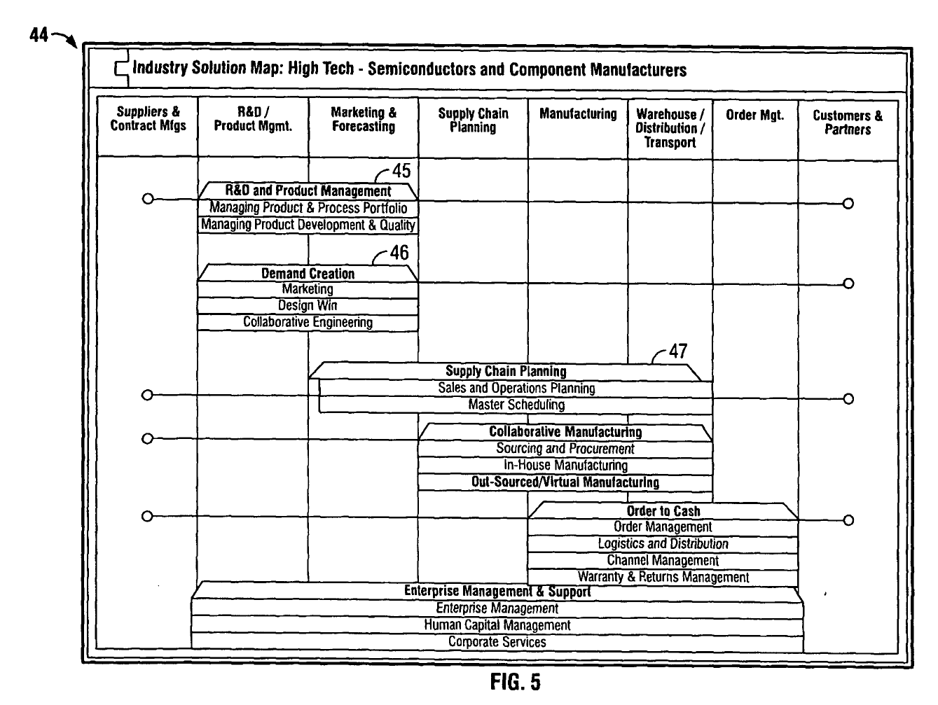

The foregoing example of a solution map relates to the automotive OEM industry. The solution maps described herein, however, are applicable to virtually any industry. For example, FIG. 5 shows a solution map 44 for the semiconductor component manufacturer industry. As shown in FIG. 5, the general format of the solution map is preserved across industries; however, the constituents thereof have been changed to reflect the relevant industry. In other words, the solution map structure remains the same, but individual elements thereof change to reflect the industry being modeled by the solution map. So, rather than having business scenarios relating to time-to-market, supplier collaboration, make-to-order, etc. (from the automotive OEM example), the solution map of FIG. 5 includes business scenarios relating to research and development and product management 45, demand creation 46, supply chain planning 47, etc.

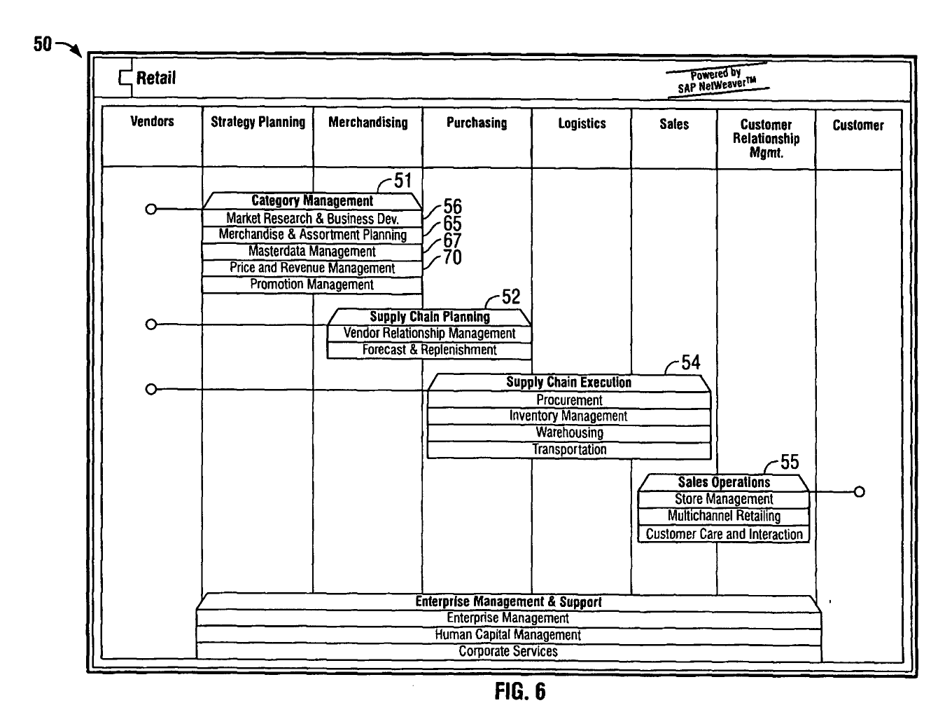

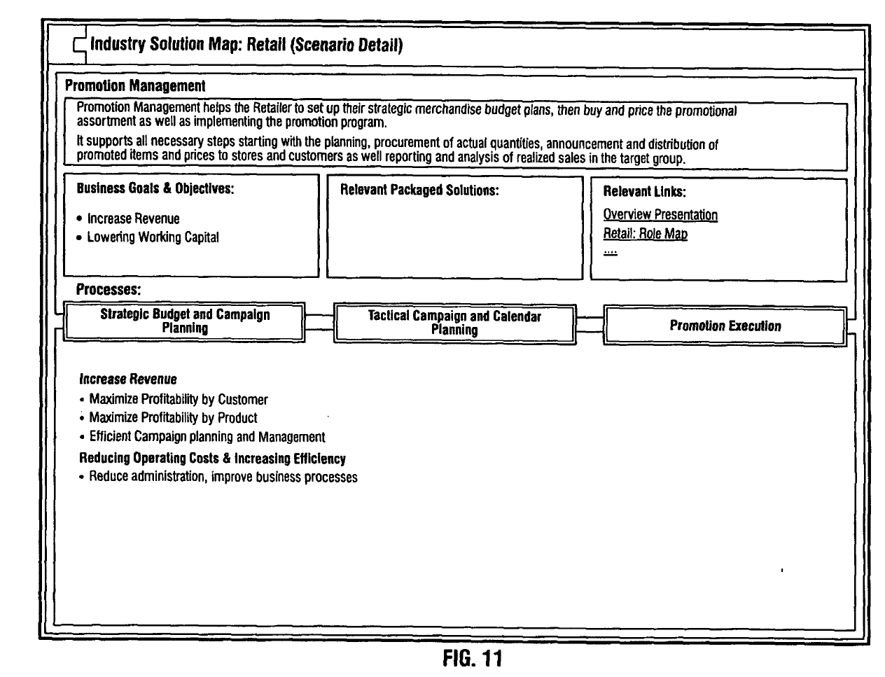

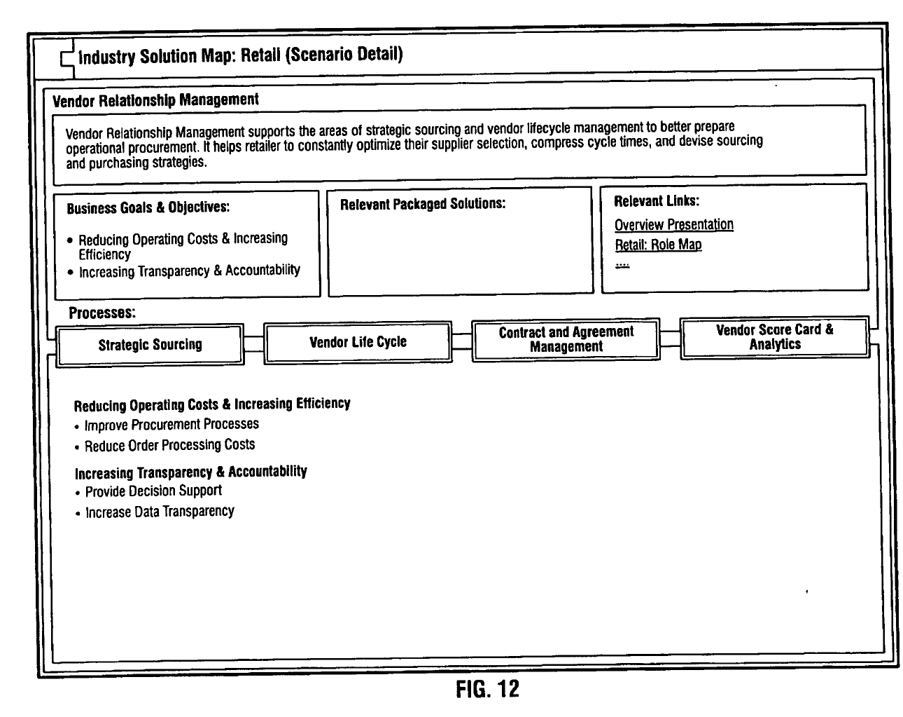

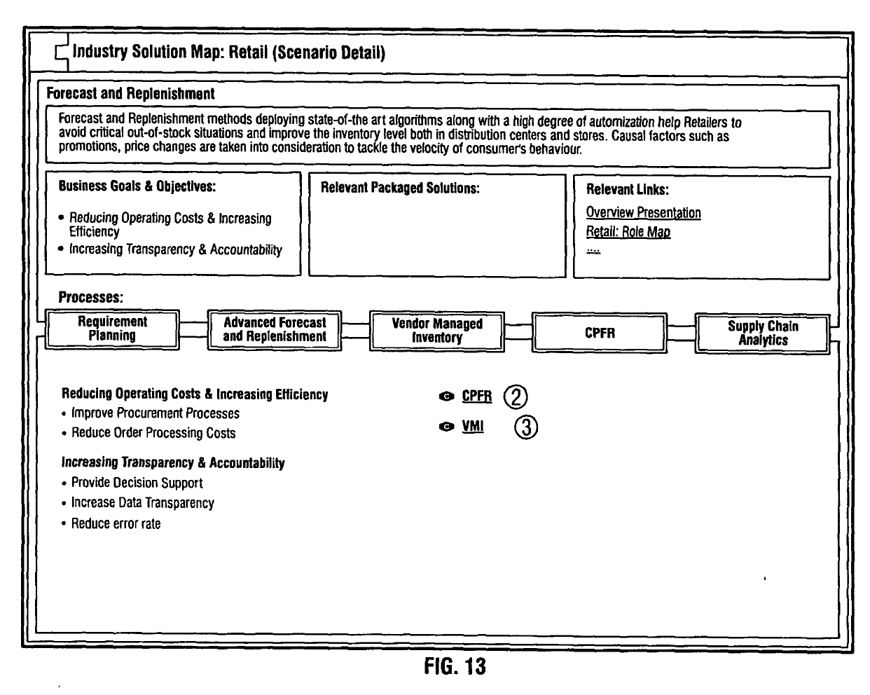

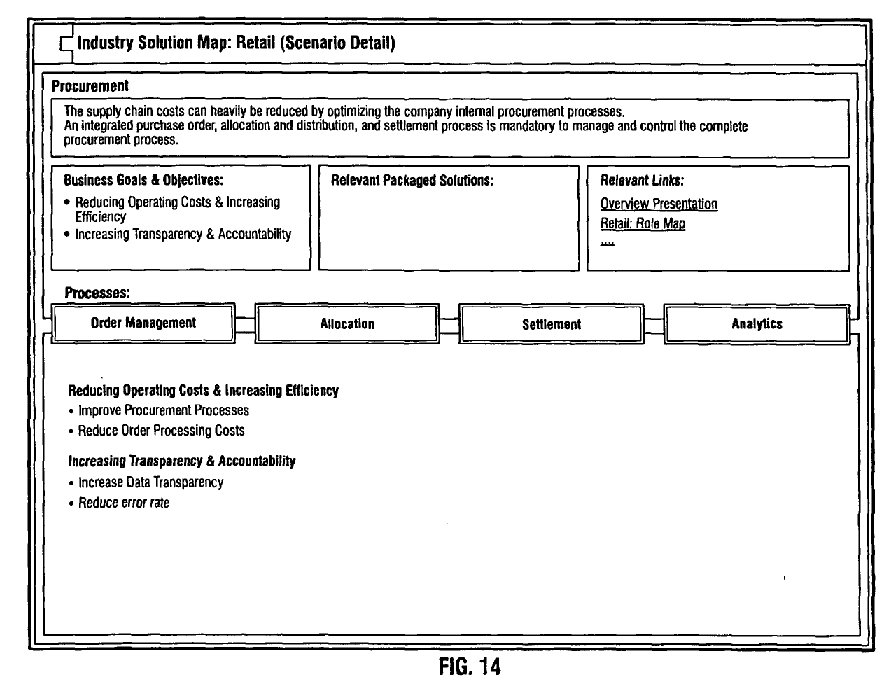

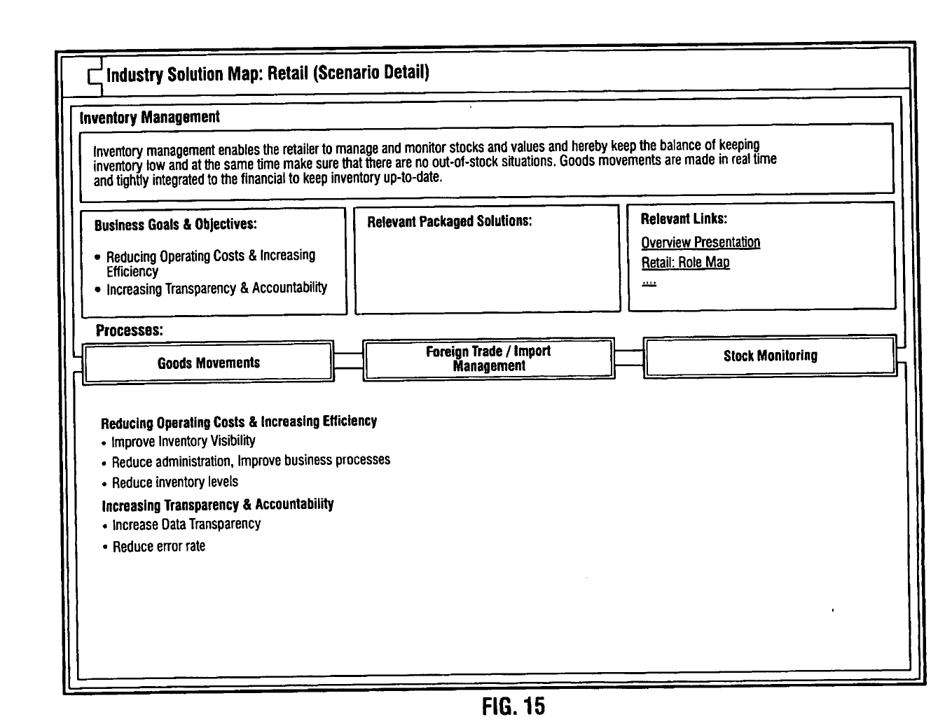

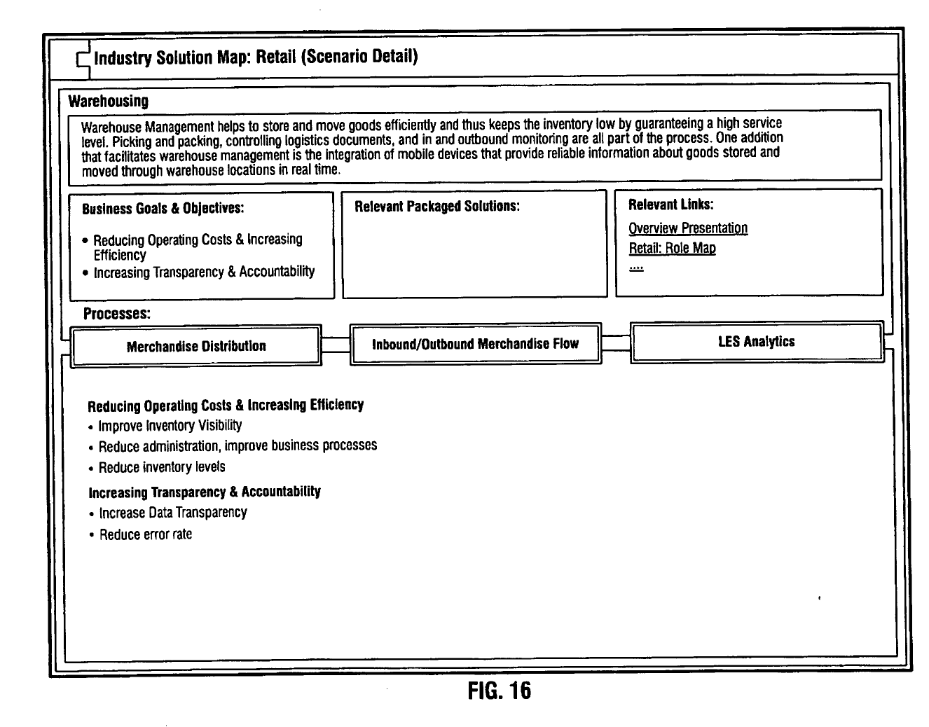

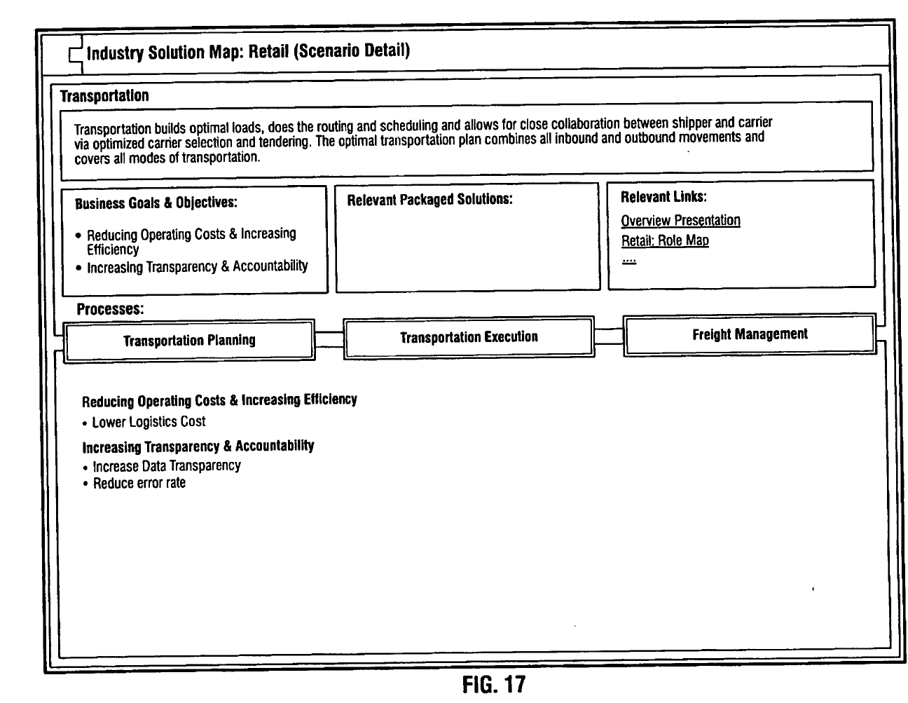

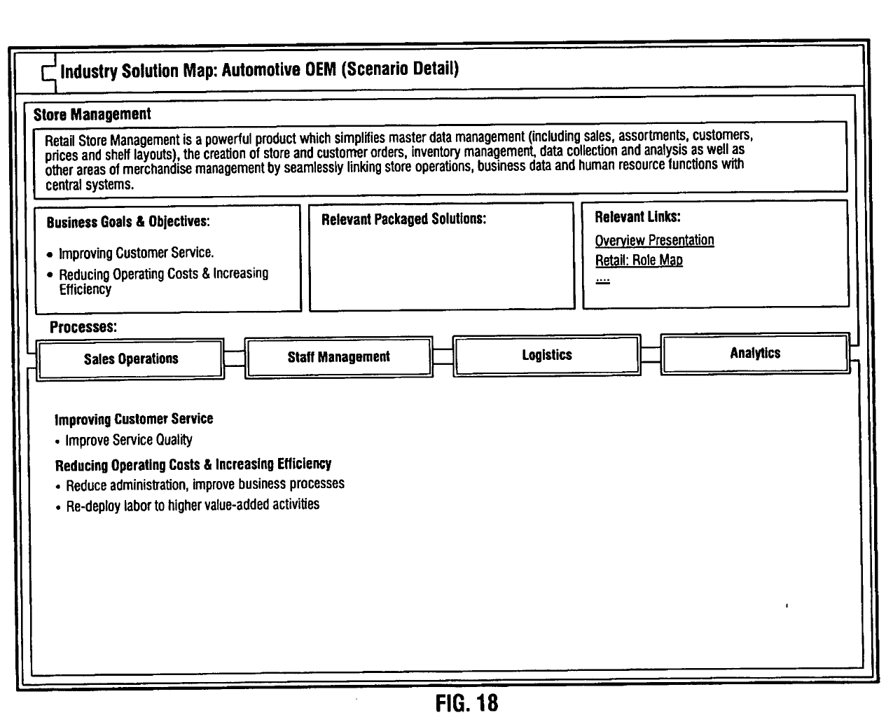

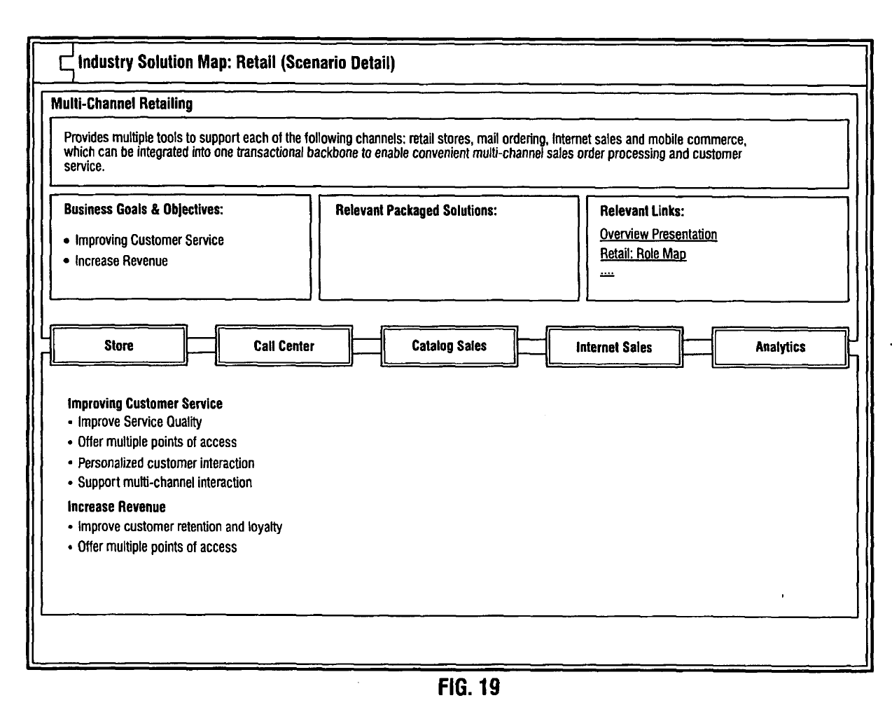

FIGS. 6 to 19 show a solution map set for use in the retail industry. Solution map 50 (FIG. 6) contains the following business scenario groups (aspects): category management 51, supply chain planning 52, supply chain execution 54, and sales operations 55. Category management 51 is directed to a retailer determining the right product mix for assortments, setting up rules for allocating stock to stores, and performing space and shelf planning. Supply chain planning 52 is directed to integrated tools for collaborating with suppliers in areas such as demand planning and replenishment. Supply chain planning 52 is also directed to alert monitoring and broadcasting, distribution network planning, and analysis of key performance indicators. Supply chain execution 54 is directed to purchasing and delivery and includes providing availability information based on real-time inventory from across a supply chain, supporting direct-store delivery management, warehouse management, inventory management, and transportation processes. Sales operations 55 is directed to building the business, integrating different sales channels, understanding customer preferences, and leveraging customer information.

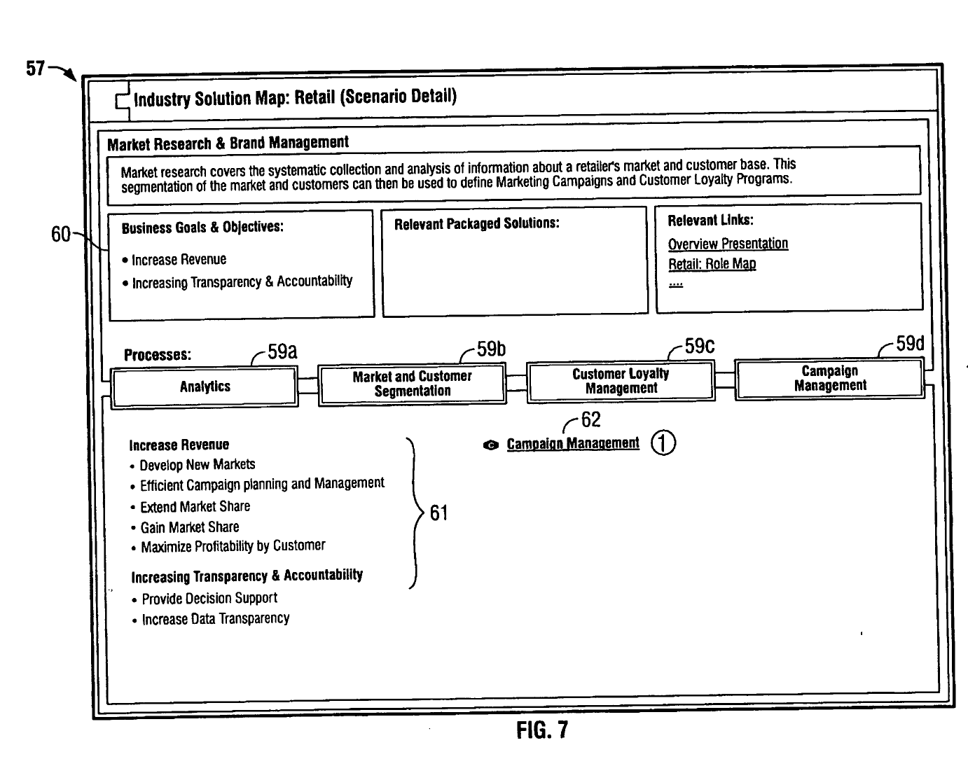

Clicking on market research and business development scenario 56 displays page 57 (FIG. 7). Page 57 contains the business processes 59a to 59d that comprise market research and business development scenario 56. Page 57 also depicts another feature of the solution maps. In page 20 (FIG. 2), process steps 27 are displayed. In page 57, a further description of the objectives 60 of the business scenario is displayed. A hyperlink may be associated with the business goals and objectives box 60, which, when clicked, displays the description 51 of page 57. A user may obtain the list of process steps by clicking on any of the business process tabs 59a to 59d. Page 57 may also contain a hyperlink 62 to another type of business map (not shown).

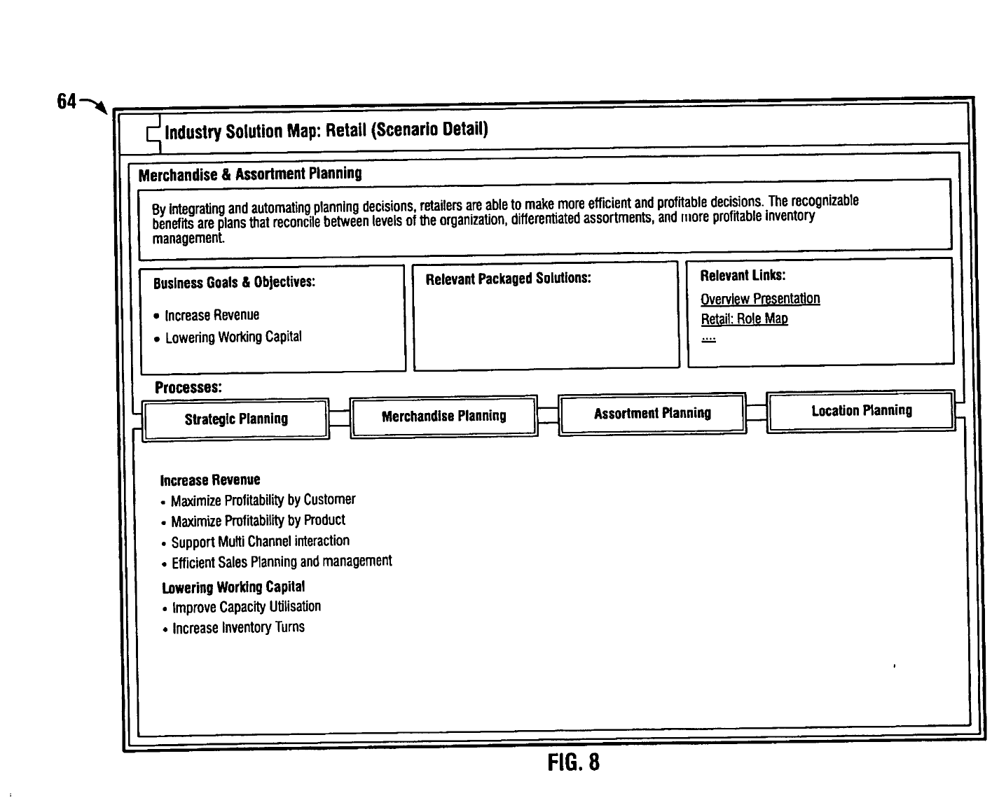

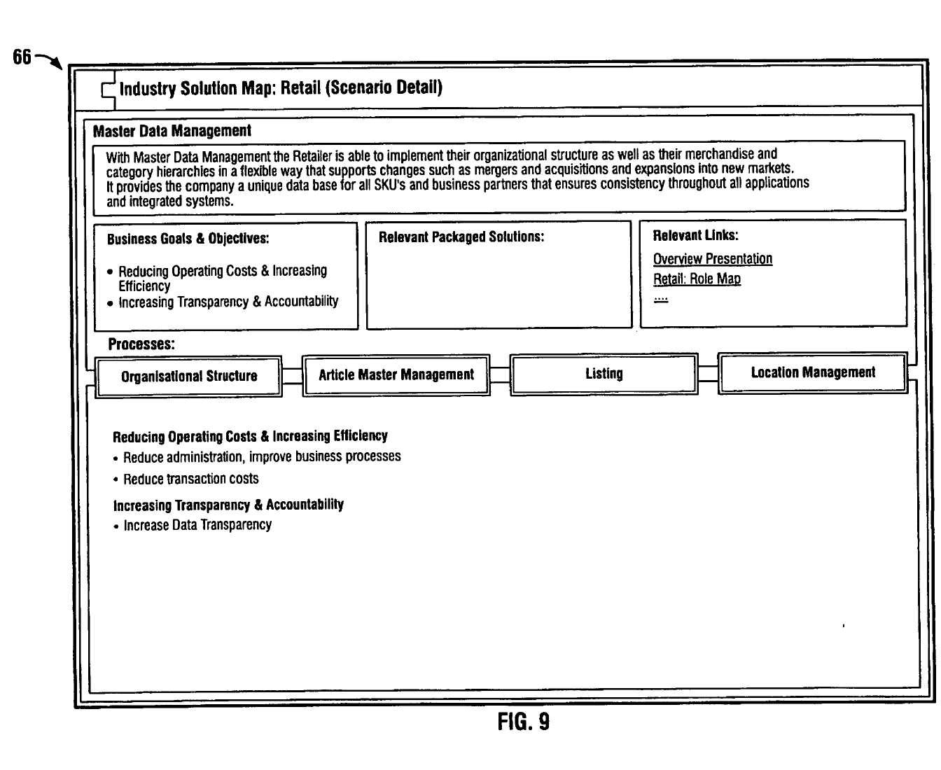

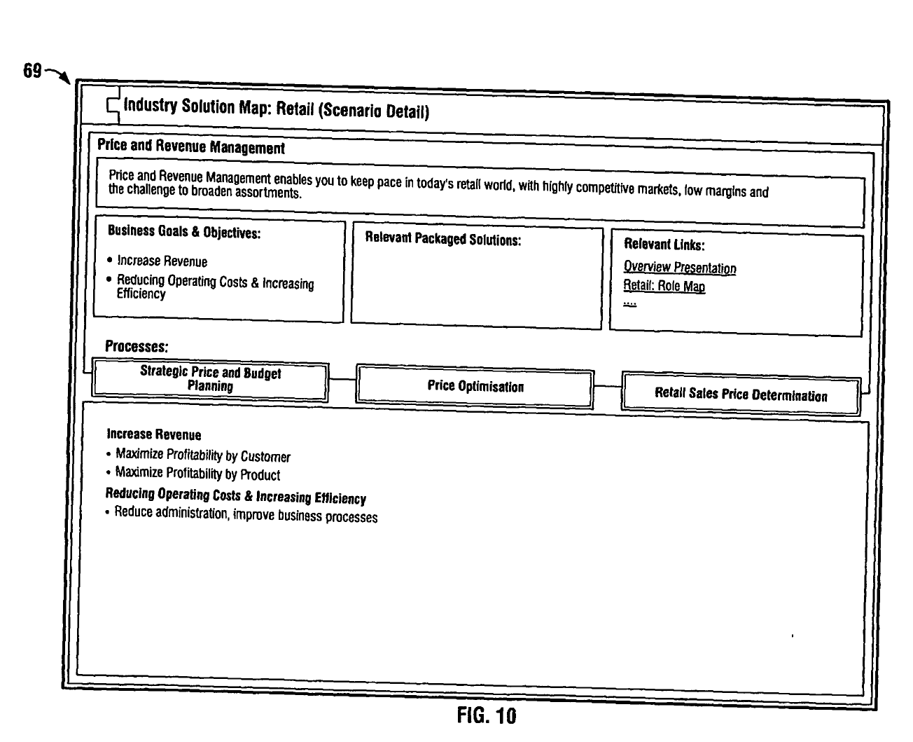

FIGS. 7 to 19 are examples of pages obtained by “drilling-down” from the business scenarios of solution map 50. For example, page 64 (FIG. 8) results from clicking on merchandise and assortment planning business scenario 65; page 66 (FIG. 9) results from clicking on masterdata management business scenario 67; page 69 (FIG. 10) results from clicking on price and revenue management business scenario 70; and so on.

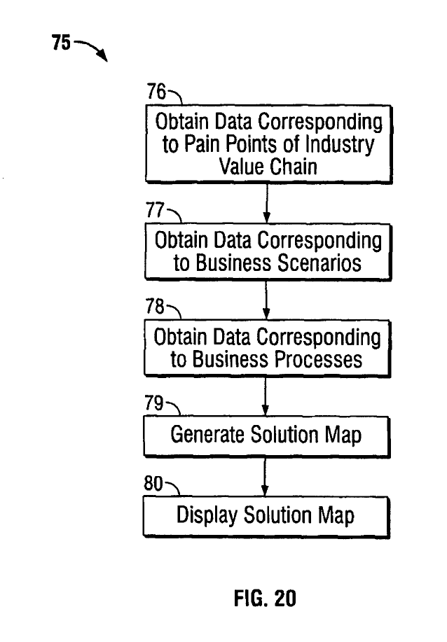

FIG. 20 shows a process 75 that may be used to generate the solution maps described herein. Process 75 may be implemented on a personal computer connected both to an intranet and the Internet, or on any other type of processing device that includes a display.

Process 75 obtains (76) data corresponding to an aspect of the business that can affect an objective of the business. This data identifies and describes pain points (defined above) that have been identified in an industry value chain. Process 75 obtains (77) data that corresponds to business scenario(s) for each pain point. The data may be based on observation, analysis, historical information, and/or other factors. Process 75 also obtains (78) data corresponding to one or more business processes that comprise the business scenario. Again, the data may be based on observation, analysis, historical information, and/or other factors. Process 75 generates (79) a solution map for the industry value chain. The solution map, which is like those described above, associates (i.e., relates) the industry value chain, the pain points, the business scenarios, and the business processes in the manner described above. Process 75 displays (80) the map, e.g., in response to user input. A user can navigate through the resulting solution map to obtain desired information, such as the identity of a product that may be used in implementing a business process.

Scenario-oriented solution maps are not limited to use with the hardware and software described herein; they may find applicability in any computing or processing environment and with any type of machine that is capable of running machine-readable instructions, such as a computer program.

Scenario-oriented solution maps can be implemented in digital electronic circuitry, or in computer hardware, firmware, software, or in combinations thereof. Scenario-oriented solution maps can be implemented via a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of process 75 can be performed by one or more programmable processors executing a computer program to perform the functions of process 75. The method steps can also be performed by, and process 75 can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data. Generally, a computer will also include, or be operatively coupled to receive data from, or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Scenario-oriented solution maps can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the record extractor, or any combination of such back-end, middleware, or front-end components. The components of the system can be interconnected by any form or medium of digital data communication, e.g., a communication network. Examples of communication networks include a local area network (“LAN”) and a wide area network (WAN”), e.g., the Internet.

The computing system can include clients and servers. A client and server are generally remote from each other and typically interact through a communication network. The relationship of client and server arises by virtue of computer programs running on respective computers and having a client-server relationship to each other.

Process 75, and the scenario-oriented solution maps produced thereby, are not limited to the implementations set forth herein. For example, the steps of process 75 can be rearranged and/or one or more such steps can be omitted to achieve similar results. The scenario-oriented solution maps may link to existing business models, thereby providing enhanced flexibility. Process 75 may be fully automated, meaning that it operates without user intervention, or interactive, meaning that all or part of the process includes some user intervention.

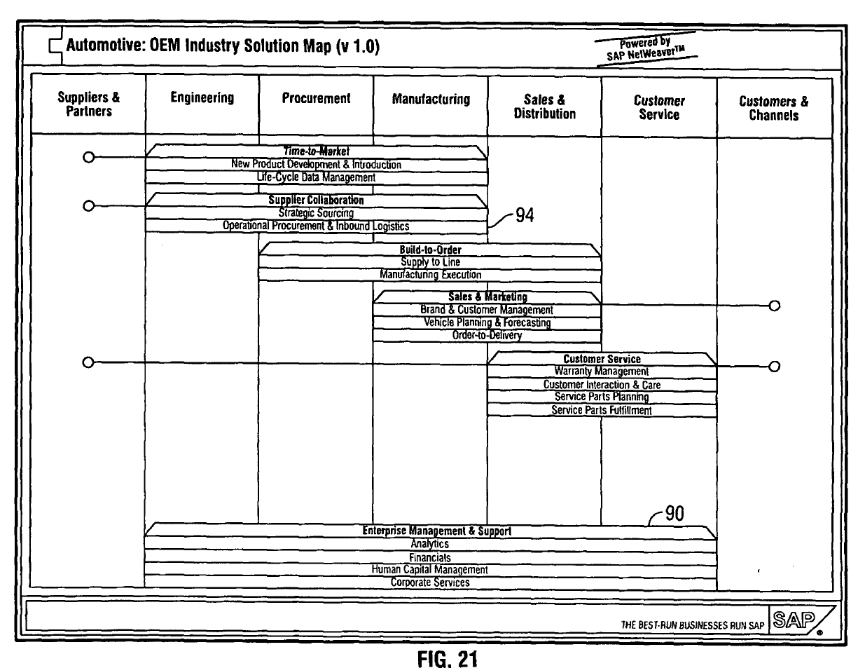

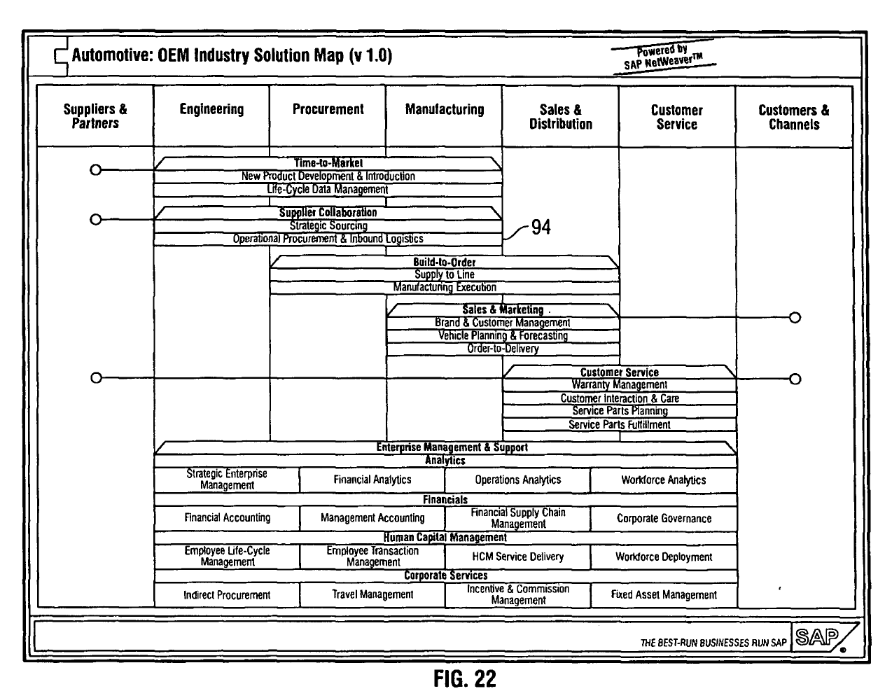

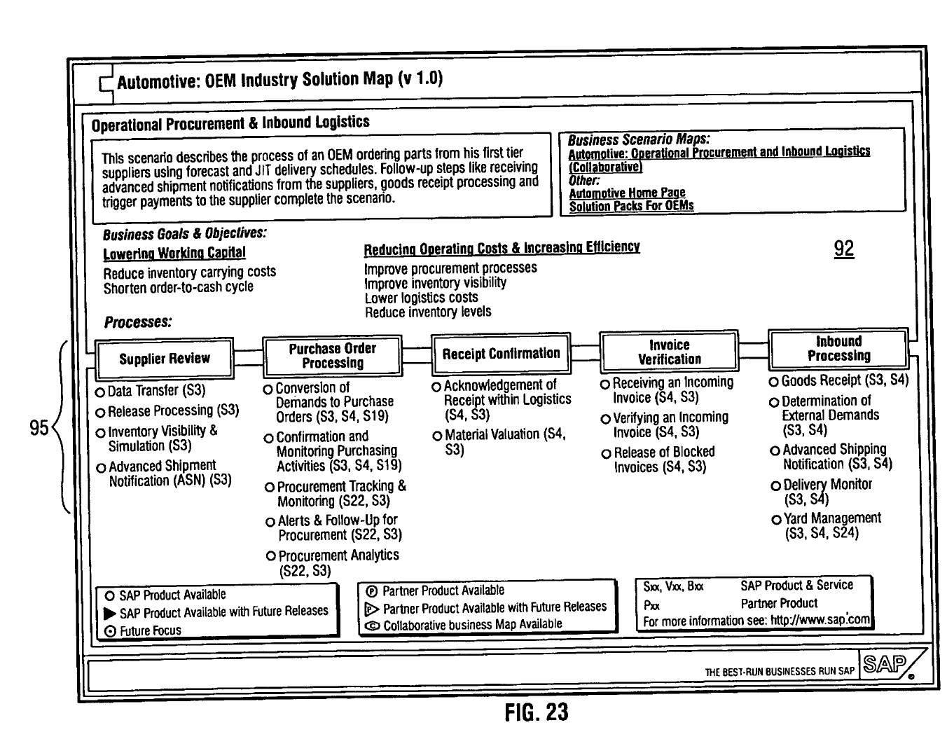

The solution maps described herein are not limited to the specific formats set forth above. For example, FIG. 21 shows an alternative embodiment for an automotive OEM solution map. In the embodiment of FIG. 21, the business scenarios are different and the enterprise resource planning map has been replaced by an enterprise management and support map. The enterprise management and support map contains links to business process categories that are different from those of FIG. 3 (see FIG. 22). FIG. 23 shows the page 92 that is displayed by clicking on the business scenario 94 for operational procurement and inbound logistics. As shown in FIG. 23, page 92 contains features 95 that are similar to those of page 20 (FIG. 2), but rearranged somewhat. Other arrangements not specifically described herein may also be used.

Elements of different embodiments may be combined to form another embodiment not specifically set forth above. Other embodiments not specifically described herein are also within the scope of the following claims.

1. A method of displaying information relating to a business, comprising:
obtaining an aspect of the business that can affect an objective of the business;
obtaining a business scenario that corresponds to the aspect;
obtaining a business process in the business scenario;
generating a map that associates the business process, the business scenario, and the aspect; and
displaying the map.

2. The method of claim 1, wherein the aspect comprises a business lever that enhances likelihood of success in the business.

3. The method of claim 1, wherein the map contains a hyperlink that connects the business scenario to the business process.

4. The method of claim 1, wherein the map contains a hyperlink associated with the business scenario, the hyperlink displaying a page containing information associated with the business scenario.

5. The method of claim 4, wherein the page contains one or both of a description of the business scenario and an element of the business process.

6. The method of claim 5, wherein the element comprises a process step that is included within the business process.

7. The method of claim 5, wherein the element contains a hyperlink to a Web page containing a product to implement the element.

8. The method of claim 1, wherein the map contains an industry value chain associated with the business, the industry value chain containing activities of the business associated with achieving the object, the aspect of the business being related to one or more activities of the industry value chain.

9. The method of claim 1, wherein the map contains links to an enterprise resource map, the enterprise resource map containing process categories with links to process steps that comprise the categories.

10. The method of claim 1, wherein the map displays the aspect relative to the business scenario and contains a link to information about the business process.

11. A computer program product for use in of displaying information relating to a business, the computer program product being tangibly embodied in an information carrier, the computer program product being operable to cause a machine to:
obtain data for an aspect of the business that can affect an objective of the business;
obtain data for a business scenario that corresponds to the aspect;
obtain data for a business process in the business scenario;
generate a map, based on the data for the business process, the data for the business scenario, and the data for the aspect, the map associating the business process, the business scenario, and the aspect; and
display the map.

12. The computer program product of claim 11, wherein the aspect comprises a business lever that enhances likelihood of success in the business.

13. The computer program product of claim 11, wherein the map contains a hyperlink that connects the business scenario to the business process.

14. The computer program product of claim 11, wherein the map contains a hyperlink associated with the business scenario, the hyperlink displaying a page containing information associated with the business scenario.

15. The computer program product of claim 14, wherein the page contains one or both of a description of the business scenario and an element of the business process.

16. The computer program product of claim 15, wherein the element comprises a process step that is included within the business process.

17. The computer program product of claim 15, wherein the element contains a hyperlink to a Web page containing a product to implement the element.

18. The computer program product of claim 11, wherein the map contains an industry value chain associated with the business, the industry value chain containing activities of the business associated with achieving the object, the aspect of the business being related to one or more activities of the industry value chain.

19. The computer program product of claim 11, wherein the map contains links to an enterprise resource map, the enterprise resource map containing process categories with links to process steps that comprise the categories.

20. The computer program product of claim 11, wherein the map displays the aspect relative to the business scenario and contains a link to information about the business process.
